(19) United States
(12) Patent Application Publication
(10) Pub. No.: US 2019/0078340 A1
(43) Pub. Date: Mar. 14, 2019

(54) FORMWORK FOR PERFORMING CASTINGS FOR PROVIDING FLOOR SLABS

(71) Applicant: FARESIN FORMWORK S.P.A., Breganze (IT)

(72) Inventor: Guido FARESIN, Bassano Del Grappa (IT)

(73) Assignee: FARESIN FORMWORK S.P.A., Breganze (IT)

(21) Appl. No.: 16/124,400

(22) Filed: Sep. 7, 2018

(30) Foreign Application Priority Data
Sep. 8, 2017 (IT) 102017000100643

(51) Int. Cl. E04G 11/48; B28B 7/00; E04G 11/54

(52) U.S. Cl. CPC E04G 11/486; B28B 7/0032; B28B 7/02; B28B 7/0017; E04G 11/54

(57) ABSTRACT

A formwork for performing castings for providing floor slabs, comprising a supporting frame which is provided by assembling prefabricated frame portions, which include at least one pair of frame-like sides, which are constituted by first uprights and crossmembers, which are arranged parallel and spaced apart and connected by connecting elements, and a supporting device for supporting beams of the formwork, which in turn comprises a second upright which can be fixed at the end to the first upright, a supporting head, for at least one supporting beam, arranged coupled slideably along the second upright, and means of reversibly locking the supporting head on a preset position which is defined along the second upright.

The present invention relates to a formwork for performing castings for providing floor slabs.

Formwork structures are known which are made up of prefabricated frames which, assembled with adapted elements such as pins, bolts and other connecting elements, make up a tower framework. At the upper end, supporting elements for the formwork are installed, for example forks on which supporting beams rest, and panels are laid on the latter to provide a surface that is flat, uniform and continuous, adapted to act as a formwork floor.

The height of such structures is easily extended.

Also known are structures that are constituted by props connected by beams and resting on supporting heads, and which have seats for laying prefabricated panels, in order to provide a flat surface that acts as a formwork floor.

Although both types of structure exhibit high supporting capacity, they are not devoid of drawbacks.

Normally the assembly of such structures involves the handling of the various different elements by only one or just a few operators.

The provision of formwork structures is therefore inconvenient and complex for the operator.

This is particularly true for providing the formwork floor in a tower framework, which requires the various components that constitute it to be brought up to the highest floor of the tower.

Furthermore, to improve the stability of the system, the operator has to lock, for example by nailing or with clip systems, the supporting beams to the upper fork elements.

From the point of view of performance, the load-bearing capacity is limited by the fact that in tower structures what are typically used are supporting beams of wood (usually cheaper than steel beams).

In the other type of formwork structure, the provision is inconvenient and complex because the supporting structure for the formwork floor requires lengthy operations owing to the necessary steps for adjusting the system in its various parts, such as vertical alignment, plumb-lining, horizontal level adjustment, etc.

In both cases, the inconvenience and complexity of assembly work to the detriment of the speed of setting up the formwork, of the safety of the operator, and of the performance of the system.

The aim of the present invention is to provide a formwork for performing castings for providing floor slabs which is capable of improving the known art in one or more of the above mentioned aspects.

Within this aim, an object of the invention is to provide a formwork that can be built easily and rapidly by the operator while ensuring a high supporting capacity.

Another object of the invention is to obtain a formwork that is high-performing both in the lower part, for vertical support, and in the upper part, for horizontal support.

Another object of the invention is to ensure the operator builds a formwork under conditions of safety, even if the structure requires a tower framework.

Furthermore, another object of the present invention is to overcome the drawbacks of the known art in a different manner to any existing solutions.

Another object of the invention is to provide a formwork that is highly reliable, easy to implement and low cost.

This aim and these and other objects which will become better apparent hereinafter are achieved by a formwork according to claim 1, optionally provided with one or more of the characteristics of the dependent claims.

Further characteristics and advantages of the invention will become better apparent from the description of a preferred, but not exclusive, embodiment of the formwork according to the invention, which is illustrated by way of non-limiting example in the accompanying drawings wherein:

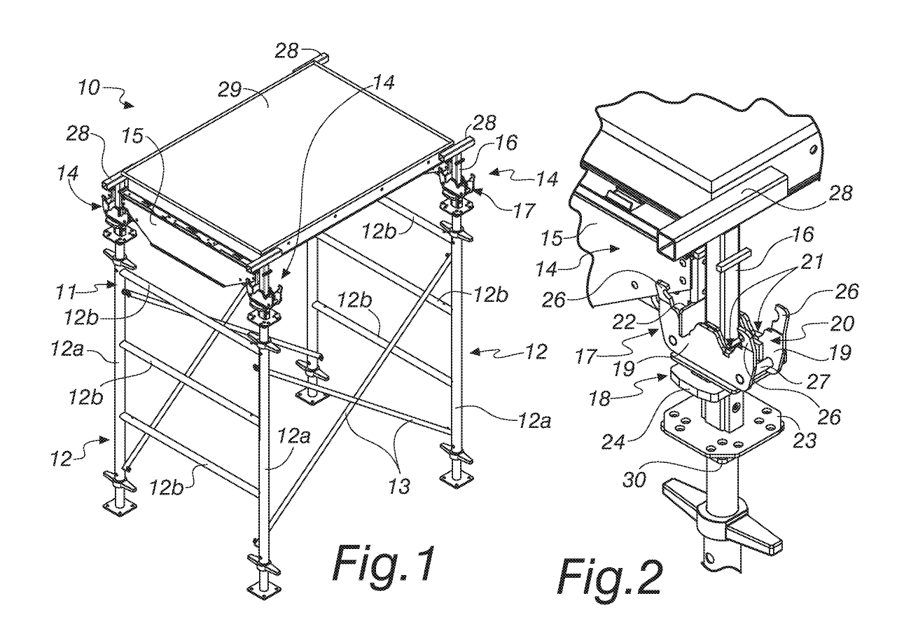

FIG. 1 shows a formwork according to the invention;

FIG. 2 is an enlargement of a detail of FIG. 1;

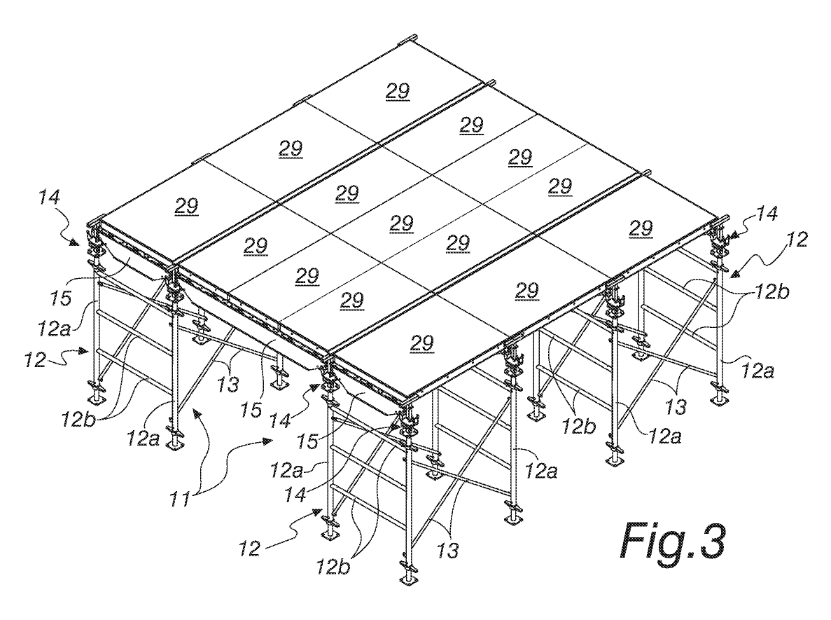

FIG. 3 shows a formwork at the end of providing the formwork floor for performing the casting.

With reference to the figures, the formwork according to the invention, which is generally designated by the reference numeral 10, comprises a supporting frame 11 which is provided by assembling prefabricated frame portions, which include at least two frame-like sides 12, which are constituted by first uprights 12a and crossmembers 12b, which are arranged parallel and spaced apart and connected by connecting elements 13, and a supporting device 14, of the drop-head type, for supporting beams 15 for the formwork. The connecting elements 13 consist, conveniently, of diagonal tie rods. The supporting device 14 in turn comprises a second upright 16 which can be fixed at the end to the first upright 12a, a supporting head 17, for at least one supporting beam 15, arranged coupled slideably along the second upright 16, and means 18 of reversibly locking the supporting head 17 on a preset position which is defined along the second upright 16.

As can be seen in the enlargement in FIG. 2, the supporting head 17 comprises:

two plates 19 which are arranged mirror-symmetrically and are laterally adjacent to mutually opposite sides of the second upright 16, and are adapted to laterally delimit a region 20 for accommodating the end of the supporting beam 15,

at least two recesses 21, for guiding the insertion and containment of a resting portion 22 of the corresponding supporting beam 15, each one of which is provided on a respective plate 19.

In particular, the two plates 19 are cut-welded on a base plate and each one of them, in the example shown, is symmetrical with respect to a vertical centerline axis and, as a pair, they consequently define two zones 20 for accommodating the ends of contiguous and aligned supporting beams 15.

Conveniently, the base plate has a through hole in the center, in order to enable it to slide along the second upright 16. In this manner it is possible to disassemble the system by sliding out a wedge 24 from the device 14, so as to allow the supporting head 17 to fall downward.

The two recesses 21 have a substantially V-shaped profile for guiding the insertion and containment of a resting portion 22 of the corresponding supporting beam 15. The resting portion 22 is represented by the lower portion of a body shaped like an upside-down T which is provided at the end of the supporting beam 15.

The supporting head 17 is provided with safety and abutment elements 26 for the end of the beam 15 during the steps of erecting and removing such beam, which take the form of hooked portions that extend, in continuation of the upper portions of the recesses 21, outward and upward from the plates 19.

The concavity of the hooked portions faces substantially toward the second upright 16. They prevent the supporting beam 15, once it is released from one of the two heads that support it at the ends, from accidentally disconnecting from the remaining head. In particular, the laterally-protruding parts of the resting portion 22 with the upside-down T-shaped body engage with the hook-shaped portions.

Furthermore, the supporting head 17 is provided with a crossmember 27 for connecting the two plates 19, which is adapted for temporarily resting a lower portion of the beam during the steps of its erection and removal, and which takes the form of a cylindrical pin welded at the ends of the two plates 19.

The second upright 16 has, at the upper end, a T-shaped portion 28 which, as shown in FIG. 1 and in FIG. 3, is helpful in delimiting the spaces intended for prefabricated panels.

The formwork 10 also comprises prefabricated panels 29, each one to be laid on two respective parallel supporting beams 15.

The various prefabricated portions can be easily joined together by way of pins and bolts and the supporting device 14 can be connected with a plate 23 to the first upright 12a (as in the case shown, or to the highest upright in the frame) by bolting to a complementary plate 30, present at the upper end of that first upright 12a.

The supporting frame 11 can be repeated in extent to provide the structure shown in FIG. 3, and also in height (not shown), to provide a tower frame.

The horizontal extension is substantially made possible by the use of supporting heads for the contiguous pairs of beams, while the height extension is obtainable by way of superimposition in succession of the sides 12, joining the uprights 12a thereof.

It should be noted that with respect to conventional structures, the formwork according to the invention can be easily assembled by virtue of the use of prefabricated components to be joined easily and quickly, at the same time increasing the load-bearing capacity of the system.

In fact, it is well known that tower structures with prefabricated portions have greater load-bearing capacity and a capacity for height extension that exceeds any other formwork system and, similarly, the system applied in the upper region, made up of the supporting device, supporting beams and prefabricated panels, offers a greater load-bearing capacity than systems constituted by beams and panels of wood.

In practice it has been found that the invention fully achieves the intended aim and objects, by making it possible to provide a formwork in safety and more easily and quickly than conventional structures, while at the same time ensuring a high load-bearing capacity and therefore enabling the provision of floor slabs of concrete of great thicknesses and at great heights.

The invention, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

What is claimed is:

1. A formwork for performing castings for providing floor slabs, comprising a supporting frame which is provided by assembling prefabricated frame portions, which include at least one pair of frame-like sides, which are constituted by first uprights and crossmembers, which are arranged parallel and spaced apart and connected by connecting elements, and a supporting device for supporting beams of said formwork, which in turn comprises a second upright which can be fixed at the end to said first upright, a supporting head, for at least one said supporting beam, arranged coupled slideably along said second upright, and means of reversibly locking said supporting head on a preset position which is defined along said second upright.

2. The formwork according to claim 1, wherein said supporting head comprises:
two plates which are arranged mirror-symmetrically and are laterally adjacent to mutually opposite sides of said second upright, and are adapted to laterally delimit a region for accommodating the end of said at least one supporting beam,
at least two recesses, for guiding the insertion and containment of a resting portion of the corresponding supporting beam, each one of which is provided on a respective plate.

3. The formwork according to claim 1, further comprising prefabricated panels to be laid on said supporting beams.

4. The formwork according to claim 1, wherein said recesses have a substantially V-shaped profile and guide the insertion and containment of a resting portion of the corresponding supporting beam, the latter being represented by the lower portion of an upside-down T-shaped body provided at the end of said supporting beam.

5. The formwork according to claim 1, wherein said second upright has, at an upper end, a T-shaped portion.
